(19) United States
(12) Patent Application Publication
(10) Pub. No.: US 2008/0099064 A1
(43) Pub. Date: May 1, 2008

(54) Solar cells which include the use of high modulus encapsulant sheets

(76) Inventor: Richard Allen Hayes, Beaumont, TX (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/588,628

(22) Filed: Oct. 27, 2006

(51) Int. Cl. H02N 6/00

(52) U.S. Cl. 136/251

(57) ABSTRACT

The present invention provides a solar cell module comprising an encapsulant layer formed of a polymeric sheet comprising an acid copolymer, an ionomer derived therefrom, or a combination thereof and having a thickness greater than or equal to 50 mils (1.25 mm).

### FIELD OF THE INVENTION

The present invention relates to solar cell modules comprising high modulus encapsulant layers.

### BACKGROUND OF THE INVENTION

As a renewable energy resource, the use of solar cell modules is rapidly expanding. With increasingly complex solar cell modules, also referred to as photovoltaic modules, comes an increased demand for enhanced functional encapsulant materials. Photovoltaic (solar) cell modules are units that convert light energy into electrical energy. Typical or conventional construction of a solar cell module consists of at least 5 structural layers. The layers of a conventional solar cell module are constructed in the following order starting from the top, or incident layer (that is, the layer first contacted by light) and continuing to the backing (the layer furthest removed from the incident layer): (1) incident layer or front-sheet, (2) front-sheet (or first) encapsulant layer, (3) voltage-generating layer (or solar cell layer), (4) back-sheet (second) encapsulant layer, and (5) backing layer or back-sheet. The function of the incident layer is to provide a transparent protective window that will allow sunlight into the solar cell module. The incident layer is typically a glass plate or a thin polymeric film (such as a fluoropolymer or polyester film), but could conceivably be any material that is transparent to sunlight.

The encapsulant layers of solar cell modules are designed to encapsulate and protect the fragile voltage-generating layer. Generally, a solar cell module will incorporate at least two encapsulant layers sandwiched around the voltage-generating layer. The optical properties of the front-sheet encapsulant layer must be such that light can be effectively transmitted to the voltage-generating layer. Until recently, poly(vinyl butyral) (PVB) and ethylene vinyl acetate (EVA) have generally been chosen as the materials for the encapsulant layers. However, EVA compositions suffer the shortcomings of low adhesion to the other components incorporated within the solar cell module, low creep resistance during the lamination process and end-use and low weathering and light stability. These shortcomings have generally been overcome through the formulation of adhesion primers, peroxide curing agents, and thermal and UV stabilizer packages into the EVA compositions, which necessarily complicates the sheet production and ensuing lamination processes.

A more recent development has been the use of higher modulus ethylene copolymers having acid functionality and ionomers derived therefrom in solar cell structures. See, for example, U.S. Pat. Nos. 5,476,553; 5,478,402; 5,733,382; 5,741,370; 5,762,720; 5,986,203; 6,114,046; 6,353,042; 6,320,116; 6,690,930 and US Patent Application Nos. 2003/0000568 and 2005/0279401.

As discussed above, one of the major functions of the encapsulant layers is to protect the fragile solar cells. The ionomeric encapsulant layers currently used in the art, however, are not sufficient in providing adequate penetration and threat resistance for the encapsulated solar cells.

Safety glass typically consists of a sandwich of two glass sheets or panels bonded together with an interlayer made of relatively thick polymer film or sheet and exhibits toughness and bondability to provide adhesion to the glass in the event of a crack or crash. Over the years, a wide variety of polymeric interlayers have been developed to produce glass laminate products with increased safety features. A part of this trend has been the use of copolyethylene ionomer resins as the glass laminate interlayer material. Such ionomer resins offer significantly higher strength than the commonly used PVB or EVA interlayers.

The present invention is related to the incorporation of ionomer interlayers, which are typically used in safety glass laminates, as encapsulant layers in solar cell modules to provide the encapsulated solar cells with enhanced penetration and threat resistance.

### SUMMARY OF THE INVENTION

In one aspect, the present invention is directed to a solar cell module comprising at least one encapsulant layer and a solar cell layer comprising one or a plurality of electronically interconnected solar cells and having a light-receiving surface and a rear surface, wherein the at least one encapsulant layer is formed of a first polymeric sheet comprising a first polymeric composition selected from the group consisting of acid copolymers, ionomers derived therefrom, and combinations thereof and having a thickness greater than or equal to 50 mils (1.25 mm). Preferably, the at least one encapsulant layer is a back-sheet encapsulant layer. More preferably, the solar cell module further comprises a front-sheet encapsulant layer that is formed of a second polymeric sheet comprising a second polymeric composition selected from the group consisting of the acid copolymers, the ionomers derived therefrom, and the combinations thereof and the first and the second polymeric sheets have a combined thickness greater than or equal to 70 mils (1.78 mm). Notably, the first and second polymeric compositions may be chemically distinct.

In another aspect, the present invention is directed to a solar cell module consisting essentially of, from top to bottom, (i) an incident layer that is laminated to, (ii) a front-sheet encapsulant layer that is laminated to, (iii) a solar cell layer comprising one or a plurality of electronically interconnected solar cells, which is laminated to, (iv) a back-sheet encapsulant layer that is laminated to, (v) a back-sheet, wherein said back-sheet encapsulant layer is formed of a first polymeric sheet comprising a first polymeric composition selected from the group consisting of acid copolymers, ionomers derived therefrom, and combinations thereof and having a thickness greater than or equal to 50 mils (1.25 mm). Preferably, the front-sheet encapsulant layer is formed of a second polymeric sheet comprising a second polymeric composition selected from the group consisting of the acid copolymers, the ionomers derived therefrom, and the combinations thereof and the first and second polymeric sheets have a combined thickness greater than or equal to 70 mils.

In yet another aspect, the present invention is related to a process of manufacturing the above-mentioned solar cell modules.

### BRIEF DESCRIPTION OF THE DRAWINGS

FIG. 1 is a cross-sectional view of one particular embodiment of a typical solar cell module or laminate 20 of the present invention, which comprises from top to bottom an incident layer 16, a front-sheet encapsulant layer 10, a solar cell layer 12, a back-sheet encapsulant layer 14, and a back-sheet 18.

### DETAILED DESCRIPTION OF THE INVENTION

To the extent permitted by the United States law, all publications, patent applications, patents, and other references mentioned herein are incorporated by reference in their entirety.

The materials, methods, and examples herein are illustrative only and the scope of the present invention should be judged only by the claims.

### DEFINITIONS

The following definitions apply to the terms as used throughout this specification, unless otherwise limited in specific instances.

Unless stated otherwise, all percentages, parts, ratios, etc., are by weight.

When the term “about” is used in describing a value or an end-point of a range, the disclosure should be understood to include the specific value or end-point referred to.

The terms “finite amount” and “finite value”, as used herein, are interchangeable and refer to an amount that is greater than zero.

In the present application, the terms “sheet” and “film” are used in their broad sense interchangeably.

In describing and/or claiming this invention, the term “copolymer” is used to refer to polymers containing two or more monomers.

### Solar Cell Modules or Laminates

The present invention relates to the use of certain polymeric sheet(s) in a solar cell module or laminate. The polymeric sheets disclosed herein typically have a modulus in the range of about 34,000 to about 80,000 psi (235-552 MPa) and provide high strength to a laminate structure produced therefrom. Specifically, the polymeric sheet disclosed herein comprises an acid copolymer, an ionomer derived therefrom, or a combination thereof.

A solar cell module or laminate typically comprises a solar cell layer formed of one or a plurality of electronically interconnected solar cells and one or more encapsulant layers, wherein the one or more encapsulant layers may be either a front-sheet encapsulant layer that is laminated to the light-receiving surface of the solar cell layer or a back-sheet encapsulant layer that is laminated to the rear surface of the solar cell layer. The solar cell module may further comprise an incident layer and/or a back-sheet, wherein the incident layer is the outer layer at the light-receiving side of the module and the back-sheet is the outer layer at the back side of the module. The solar cell module disclosed herein may yet further comprises other additional layers of films or sheets.

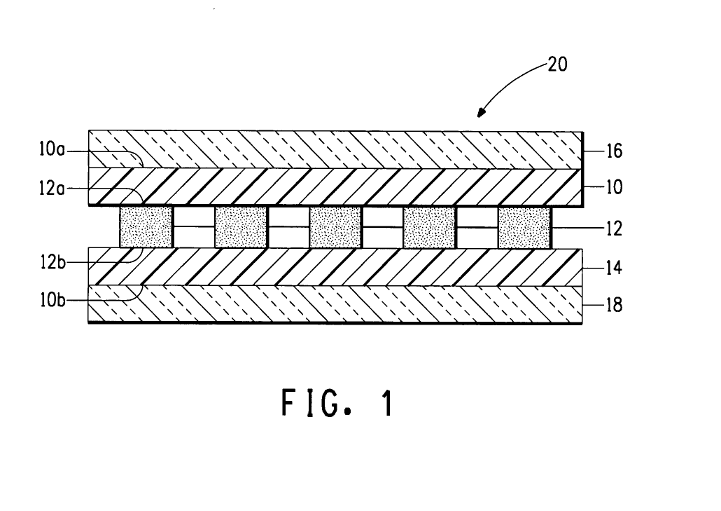

FIG. 1 demonstrates one particular construction of the solar cell module disclosed herein, wherein the solar cell module 20 comprises a solar cell layer 12 formed of one or plurality of electronically interconnected solar cells, a front-sheet encapsulant layer 10 laminated to the light-receiving surface 12a of the solar cell layer, a back-sheet encapsulant layer 14 laminated to the rear surface 12b of the solar cell layer, an incident layer 16 laminated to the light-receiving surface 10a of the front-sheet encapsulant layer, and a back-sheet 18 laminated to the rear-surface 14b of the back-sheet encapsulant layer.

In one aspect, the present invention is a solar cell module comprising at least one layer of the polymeric sheet disclosed herein serving as an encapsulant layer, or preferably, a back-sheet encapsulant layer, and the at least one polymeric sheet used herein has a thickness greater than or equal to 50 mils (1.25 mm), or preferably, greater than or equal to 60 mils (1.50 mm). Such polymeric sheets with a thickness of more than 90 mils (2.25 mm), or more than 120 mils (3.00 mm) may also be used herein In another aspect, the present invention is a solar cell module comprising at least two layers of the polymeric sheet disclosed herein with both serving as encapsulant layers, wherein, preferably, one of the at least two polymeric sheets used herein serves as a back-sheet encapsulant layer and has a thickness greater than or equal to about 50 mils; and the total thickness of the at least two polymeric sheets used herein is greater than or equal to 70 mils (1.78 mm),

### I. Encapsulant Layers:

In accordance to the present invention, at least one of the encapsulant layers included in the solar cell module of the present invention, preferably, a back-sheet encapsulant layer, is derived from the polymeric sheet disclosed herein which comprises an acid copolymer, an ionomer derived therefrom, or a combination thereof and has a thickness greater than or equal to 50 mils, while the other encapsulant layer(s) may be derived from any type of suitable films or sheets. Such suitable films or sheets include, but are not limited to, films or sheets comprising poly(vinyl butyral), ionomers, EVA, acoustic poly(vinyl acetal), acoustic poly(vinyl butyral), PVB, PU, PVC, metallocene-catalyzed linear low density polyethylenes, polyolefin block elastomers, ethylene acrylate ester copolymers, such as poly(ethylene-co-methyl acrylate) and poly(ethylene-co-butyl acrylate), acid copolymers, silicone elastomers and epoxy resins.

Also in accordance to the present invention, at least two of the encapsulant layers included in the solar cell module of the present invention are derived from the polymeric sheet disclosed herein, wherein, preferably, one of the at least two encapsulant layers is a back-sheet encapsulant layer and has a thickness greater than or equal to 50 mils and the total thickness of the at least two encapsulant layers is greater than or equal to 70 mils.

I.I Polymeric Compositions:

The acid copolymers used herein to form the polymeric sheet comprise a finite amount of polymerized residues of a α-olefin and greater than or equal to about 1 wt % of polymerized residues of a α,β-ethylenically unsaturated carboxylic acid based on the total weight of the acid copolymer. Preferably, the acid copolymer contains greater than or equal to about 10 wt %, or more preferably, about 15 to about 25 wt %, or most preferably, about 18 to about 23 wt %, of polymerized residues of the α,β-ethylenically unsaturated carboxylic acid, based on the total weight of the acid copolymer to provide enhanced adhesion, clarity, percent light transmission and physical properties, such as higher flexural moduli and stiffness.

The α-olefin used herein incorporates from 2 to 10 carbon atoms. The α-olefin may be selected from the group consisting of ethylene, propylene, 1-butene, 1-pentene, 1-hexene, 1-heptene, 3-methyl-1-butene, 4-methyl-1-pentene, and the like and mixtures thereof. Preferably, the α-olefin is ethylene. The α,β-ethylenically unsaturated carboxylic acid used herein may be selected from the group consisting of acrylic acids, methacrylic acids, itaconic acids, maleic acids, maleic anhydrides, fumaric acids, monomethyl maleic acids, and mixtures thereof. Preferably, the α,β-ethylenically unsaturated carboxylic acid is selected from the group consisting of acrylic acids, methacrylic acids and mixtures thereof.

The acid copolymers may further comprise polymerized residues of at least one other unsaturated comonomer. Specific examples of such other unsaturated comonomers include, but are not limited to, methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol)methyl ether acrylate, poly(ethylene glycol)methyl ether methacrylate, poly(ethylene glycol)behenyl ether acrylate, poly(ethylene glycol)behenyl ether methacrylate, poly(ethylene glycol)4-nonylphenyl ether acrylate, poly(ethylene glycol)4-nonylphenyl ether methacrylate, poly(ethylene glycol)phenyl ether acrylate, poly(ethylene glycol)phenyl ether methacrylate, dimethyl maleate, diethyl maleate, dibutyl maleate, dimethyl fumarate, diethyl fumarate, dibutyl fumarate, dimenthyl fumarate and the like and mixtures thereof. Preferably, the other unsaturated comonomers are selected from the group consisting of methyl acrylate, methyl methacrylate, butyl acrylate, butyl methacrylate, glycidyl methacrylate and mixtures thereof. The acid copolymers used herein may incorporate from 0 to about 50 wt % of polymerized residues of the other unsaturated comonomers, based on the total weight of the composition. Preferably, the acid copolymers used herein incorporate from 0 to about 30 wt %, or more preferably, from 0 to about 20 wt %, of polymerized residues of the other unsaturated comonomers. The acid copolymers used herein may be polymerized as disclosed, for example, in U.S. Pat. Nos. 3,404,134; 5,028,674; 6,500,888; and 6,518,365.

The ionomeric compositions used herein to form the polymeric sheet are derived from certain of the above mentioned acid copolymers. In preparing the ionomers used herein, the parent acid copolymers are neutralized from about 10% to about 100%, or preferably, from about 10% to about 50%, or more preferably, from about 20% to about 40%, with metallic ions based on the total carboxylic acid content. The metallic ions used herein may be monovalent, divalent, trivalent, multivalent, and mixtures thereof. Preferable monovalent metallic ions are selected from the group consisting of sodium, potassium, lithium, silver, mercury, copper, and the like and mixtures thereof. Preferable divalent metallic ions may be selected form the group consisting of beryllium, magnesium, calcium, strontium, barium, copper, cadmium, mercury, tin, lead, iron, cobalt, nickel, zinc, and the like and mixtures thereof. Preferable trivalent metallic ions may be selected from the group consisting of aluminum, scandium, iron, yttrium, and the like and mixtures thereof. Preferable multivalent metallic ions may be selected from the group consisting of titanium, zirconium, hafnium, vanadium, tantalum, tungsten, chromium, cerium, iron, and the like and mixtures thereof. When the metallic ion is multivalent, complexing agents, such as stearate, oleate, salicylate, and phenolate radicals may be included, as disclosed within U.S. Pat. No. 3,404,134. More preferably, the metallic ions are selected from the group consisting of sodium, lithium, magnesium, zinc, aluminum, and mixtures thereof. Even more preferably, the metallic ions are selected from the group consisting of sodium, zinc, and mixtures thereof. Most preferably, the metallic ion is zinc. The parent acid copolymers may be neutralized as disclosed, for example, in U.S. Pat. No. 3,404,134.

It is preferred that the parent acid copolymer resin used herein has a melt index (MI) less than 60 g/10 min, or more preferably, less than 55 g/10 min, or even more preferably, less than 50 g/10 min, or most preferably, less than 35 g/10 min, as measured by ASTM method D1238 at 190° C. And, the resulting ionomer resins should preferably have a MI less than about 10 g/10 min, or more preferably, less than 5 g/10 min, or most preferably, less than 3 g/10 min. The ionomer resins should also have a flexural modulus greater than about 40,000 psi, or preferably, greater than about 50,000 psi, or most preferably, greater than about 60,000 psi, as measured by ASTM method D638. The ionomer resins used herein exhibit improved toughness relative to what would be expected of an ionomeric sheet comprising a higher acid content. It is believed that the improved toughness is obtained by preparing an acid copolymer base resin with a lower MI before it is neutralized.

The acid copolymers and/or ionomers used herein may further contain additives which effectively reduce the melt flow of the resin, to the limit of producing thermoset films or sheets. The use of such additives will enhance the upper end-use temperature and reduce creep of the encapsulant layer and laminates of the present invention, both during the lamination process and the end-uses thereof. Typically, the end-use temperature will be enhanced up to 20° C. to 70° C. In addition, laminates produced from such materials will be fire resistant. By reducing the melt flow of the polymeric films or sheets of the present invention, the material will have a reduced tendency to melt and flow out of the laminate and therefore less likely to serve as additional fire fuel. Specific examples of melt flow reducing additives include, but are not limited to, organic peroxides, such as 2,5-dimethylhexane-2,5-dihydroperoxide, 2,5-dimethyl-2,5-di(tert-betylperoxy)hexane-3, di-tert-butyl peroxide, tert-butylcumyl peroxide, 2,5-dimethyl-2,5-di(tert-butylperoxy)hexane, dicumyl peroxide, alpha, alpha′-bis(tert-butyl-peroxyisopropyl)benzene, n-butyl-4,4-bis(tert-butylperoxy)valerate, 2,2-bis(tert-butylperoxy)butane, 1,1-bis(tert-butyl-peroxy)cyclohexane, 1,1-bis(tert-butylperoxy)-3,3,5-trimethyl-cyclohexane, tert-butyl peroxybenzoate, benzoyl peroxide, and the like and mixtures or combinations thereof. The organic peroxide may decompose at a temperature of about 100° C. or higher to generate radicals. Preferably, the organic peroxides have a decomposition temperature which affords a half life of 10 hours at about 70° C. or higher to provide improved stability for blending operations. Typically, the organic peroxides will be added at a level of between about 0.01 and about 10 wt % based on the total weight of composition. If desired, initiators, such as dibutyltin dilaurate, may be used. Typically, initiators are added at a level of from about 0.01 to about 0.05 wt % based on the total weight of composition. If desired, inhibitors, such as hydroquinone, hydroquinone monomethyl ether, p-benzoquinone, and methylhydroquinone, may be added for the purpose of enhancing control to the reaction and stability. Typically, the inhibitors would be added at a level of less than about 5 wt % based on the total weight of the composition. However, for the sake of process simplification and ease, it is preferred that the encapsulant layer used herein does not incorporate cross-linking additives, such as the abovementioned peroxides.

It is understood that the acid copolymers and/or ionomers used herein may further contain any additive known within the art. Such exemplary additives include, but are not limited to, plasticizers, processing aides, flow enhancing additives, lubricants, pigments, dyes, flame retardants, impact modifiers, nucleating agents to increase crystallinity, antiblocking agents such as silica, thermal stabilizers, hindered amine light stabilizers (HALS), UV absorbers, UV stabilizers, dispersants, surfactants, chelating agents, coupling agents, adhesives, primers, reinforcement additives, such as glass fiber, fillers and the like.

Thermal stabilizers are well disclosed within the art. Any known thermal stabilizer will find utility within the present invention. General classes of thermal stabilizers include, but are not limited to, phenolic antioxidants, alkylated monophenols, alkylthiomethylphenols, hydroquinones, alkylated hydroquinones, tocopherols, hydroxylated thiodiphenyl ethers, alkylidenebisphenols, O—, N— and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. The ionomeric compositions disclosed herein may comprise 0 to about 10.0 wt % of the thermal stabilizers, based on the total weight of the composition. Preferably, the polymeric compositions disclosed herein comprise 0 to about 5.0 wt %, or more preferably, 0 to about 1.0 wt % of the thermal stabilizers.

UV absorbers are well disclosed within the art. Any known UV absorber will find utility within the present invention. Preferable general classes of UV absorbers include, but are not limited to, benzotriazoles, hydroxybenzophenones, hydroxyphenyl triazines, esters of substituted and unsubstituted benzoic acids, and the like and mixtures thereof. The ionomeric compositions disclosed herein may comprise 0 to about 10.0 wt % of the UV absorbers, based on the total weight of the composition. Preferably, the polymeric compositions disclosed herein comprise 0 to about 5.0 wt %, or more preferably, 0 to about 1.0 wt % of the UV absorbers.

Generally, HALS are disclosed to be secondary, tertiary, acetylated, N-hydrocarbyloxy substituted, hydroxy substituted N-hydrocarbyloxy substituted, or other substituted cyclic amines which further incorporate steric hindrance, generally derived from aliphatic substitution on the carbon atoms adjacent to the amine function. Essentially any HALS known within the art may find utility within the present invention. The polymeric compositions disclosed herein may comprise 0 to about 10.0 wt % of HALS, based on the total weight of the composition. Preferably, the ionomeric compositions disclosed herein comprise 0 to about 5.0 wt %, or more preferably, 0 to about 1.0 wt % of HALS.

Silane coupling agents may be added in the ionomeric compositions to enhance the adhesive strengths. Specific examples of the silane coupling agents include, but are not limited to, gamma-chloropropylmethoxysilane, vinyltriethoxysilane, vinyltris(beta-methoxyethoxy)silane, gamma-methacryloxypropylmethoxysilane, vinyltriacetoxysilane, gamma-glycidoxypropyltrimethoxysilane, gamma-glycidoxypropyltriethoxysilane, beta-(3,4-epoxycyclohexyl)ethyltrimethoxysilane, vinyltrichlorosilane, gamma-mercaptopropylmethoxysilane, gamma-aminopropyltriethoxysilane, N-beta-(aminoethyl)-gamma-aminopropyltrimethoxysilane, and the like and mixtures thereof. These silane coupling agent materials may be used at a level of about 5 wt % or less, or preferably, about 0.001 to about 5 wt %, based on the total weight of the resin composition.

I.II. Thickness:

As discussed above, the polymeric composition of the polymeric sheets disclosed herein has a modulus in the range of 34,000-80,000 psi. Such polymeric sheets with a thickness greater than or equal to 50 mils have been used as interlayers in glass laminates to provide improved strength and penetration and threat resistance.

In accordance to the present invention, at least one layer of the polymeric sheet disclosed herein which has a thickness greater than or equal to 50 mils, or preferably, greater than or equal to 60 mils, is included in the present solar cell module as an encapsulant layer. Preferably, the polymeric sheet used herein is in direct contact with a glass layer, the solar cell layer, or both. The inclusion of such a thick polymeric sheet provides the solar cell module with high strength and improved penetration and threat resistance generally assumed for safety glass and desirable as architectural glazings and as automotive sun or moon roofs.

Due to the improved penetration and threat resistance feature, it is conceivable that the solar cell modules of the present invention may be imbedded in, or be part of, an architectural glazing or an automotive sun roof.

I.III. Surface Roughness of the Encapsulant Layers:

The encapsulant layers comprised in the solar cell module of the present invention may have smooth or roughened surfaces. Preferably, the encapsulant layers have roughened surfaces to facilitate the de-airing of the laminates through the laminate process. The efficiency of the solar cell module is related to the appearance and transparency of the transparent front-sheet portion of the solar cell laminates and is an important feature in assessing the desirability of using the laminates. As described above, the front-sheet portion of the solar cell laminate includes the top incident layer, the solar cell layer (voltage-generating solar cell) and the encapsulant layer and any other layers laminated between the incident layer and the solar cell layer. One factor affecting the appearance of the front-sheet portion of the solar cell laminates is whether the laminate includes trapped air or air bubbles between the encapsulant layer and the rear surface of the incident layer, or between the encapsulant layer and the light-receiving surface of the solar cell layer. It is desirable to remove air in an efficient manner during the lamination process. Providing channels for the escape of air and removing air during lamination is a known method for obtaining laminates with acceptable appearance.

This can be effected by mechanically embossing or by melt fracture during extrusion followed by quenching so that the roughness is retained during handling. Retention of the surface roughness is preferable in the practice of the present invention to facilitate effective de-airing of the entrapped air during laminate preparation.

Surface roughness, Rz, can be expressed in microns by a 10-point average roughness in accordance with ISO-R468 of the International Organization for Standardization and ASMEB46.1 of the American Society of Mechanical Engineers. For sheets and films having a thickness of the present invention, 10-point average roughness, Rz, of up to 80 μm is sufficient to prevent air entrapment. The width of the channels may range from about 30 to about 300 μm, or preferably, from about 40 to about 250 μm, or more preferably, from about 50 to about 200 μm. The surface channels may be spaced from about 0.1 to about 1 mm apart, or preferably, from about 0.1 to about 0.9 mm apart, or more preferably, from about 0.15 to about 0.85 mm apart.

Surface roughness, Rz, measurements from single-trace profilometer measurements can be adequate in characterizing the average peak height of a surface with roughness peaks and valleys that are nearly randomly distributed. However a single trace profilometer may not be sufficient in characterizing the texture of a surface that has certain regularities, particularly straight lines. In characterizing such surfaces, if care is taken such that the stylus does not ride in a groove or on a plateau, the Rz thus obtained can still be a valid indication of the surface roughness. Other surface parameters, such as the mean spacing (R Sm) may not be accurate because they depend on the actual path traversed. Parameters like R Sm can change depending on the angle the traversed path makes with the grooves. Surfaces with regularities like straight-line grooves are better characterized by three-dimensional or area roughness parameters such as the area peak height, ARp, and the total area roughness, ARt, and the area kurtosis (AKu) as defined in ASME B46.1. ARp is the distance between the highest point in the roughness profile over an area to the plane if all the material constituting the roughness is melted down. ARt is the difference in elevation between the highest peak and the lowest valley in the roughness profile over the area measured. In the instant invention, the surface pattern of the ionomer and/or other polymeric surface layers of the multilayer encapsulant layer 10 are characterized by ARₜ less than 32 μm, and the ratio of ARp to ARₜ, also defined in ASME B46.1-1, may be between 0.42 and 0.62, or preferably, between 0.52 and 0.62. The ionomer and/or other polymeric surface layers of the multilayer encapsulant layer 10 may also have area kurtosis of less than about 5.

The present invention can be suitably practiced with any of the surface patterns described above. The surface pattern is preferably an embossed pattern. The channel depth may range from about 2 to about 80 μm, or preferably, from about 2 to about 25 μm, or more preferably, from about 12 to about 20 μm, or most preferably, from about 14 to about 20 μm. The depth may be selected so that the regular channels provide suitable paths for air to escape during the lamination process. It is desirable therefore that the depth be sufficiently deep that the air pathways are not cut off prematurely during the heating stage of the lamination process, leading to trapped air in the laminate when it cools. Also, particularly when using the higher modulus polymeric layers comprising ionomers, it can be desirable to provide relatively shallow channels in comparison to, for example, EVA or PVB interlayer surface patterns. Larger channels provide larger reservoirs for air, and hence more air that requires removal during lamination.

The encapsulant layers can be embossed on one or both sides. The embossing pattern and/or the depth thereof can be asymmetric with respect to the two sides of the multilayer encapsulant layer. That is, the embossed patterns can be the same or different, as can be the depth of the pattern on either side of the multilayer encapsulant layers. In a specific embodiment, the surface layers comprising ionomers and/or other polymeric compositions has an embossed pattern wherein the depth of the pattern on each side is in the range of from about 12 to about 20 μm. In another specific embodiment, there is an embossed pattern on one side of the multilayer encapsulant layer 10 that is orthogonal to the edges of layer, while the identical embossed pattern on the opposite side of the multilayer encapsulant layer 10 is slanted at some angle that is greater than or less than 90° to the edges. Offsetting the patterns in this manner can eliminate an undesirable optical effect in the layers.

In one particular embodiment, a surface pattern can be applied using a tool that imparts a pattern wherein the pattern requires less energy to obtain a flattened surface than conventional patterns. In the process of the present invention it is necessary to flatten the surface of the encapsulant layer during the lamination, so that the encapsulant layer surface is in complete contact with the opposing surface to which it is being laminated when the lamination process is complete. The energy required to obtain a smooth or flattened surface can vary depending upon the surface topography, as well as the type of material being flattened.

Conventional surface patterns or textures require a large percentage of the volume of the material that is raised above the imaginary plane of the flattened multilayer encapsulant layer sheet to flow to areas that lie below the imaginary plane. Encapsulant layer material that is above (primarily) and below the plane (which is the interface of the encapsulant layer and the layer to which it is being laminated to, (such as the solar cell layer, for example), after the lamination step is complete) must flow through a combination of heat, applied pressure, and time. Each particular pattern of different peak heights, spacing, volume, and other descriptors necessary to define the surface geometry will yield a corresponding amount of work or energy to compress the surface pattern. The goal is to prevent premature contact or sealing to occur prior to sufficient air removal being accomplished whether air removal is to be achieved by conventional techniques such as roll pre-pressing or vacuum bags/rings and the like.

In another embodiment, an encapsulant layer having a surface roughness that allows for high-efficiency de-airing but with less energy for compression (or at a controlled and desired level tailored for the pre-press/de-airing process) is obtained. One example of a surface pattern used in the present invention comprises projections upward from the base surface as well as voids, or depressions, in the encapsulant layer surface. Such projections and depressions would be of similar or the same volume, and located in close proximity to other such projections and voids on the encapsulant layer surface. The projections and depressions may be located such that heating and compressing the encapsulant layer surface results in more localized flow of the thermoplastic material from an area of higher thermoplastic mass (that is, a projection) to a void area (that is, depression), wherein such voids would be filled with the mass from a local projection, resulting in the encapsulant layer surface being flattened. Localized flow of the thermoplastic resin material to obtain a flattened surface would require less of an energy investment than a more conventional pattern, which requires flattening of a surface by effecting mass flow of thermoplastic material across the entire surface of the encapsulant layer. The main feature is the ability for the pattern to be flattened with relative ease as compared with the conventional art.

Several different criteria are important in the design of an appropriate surface pattern or texture for handling, ease of positioning, blocking tendency, ease of cleaning, de-airing and possessing a robust process window for laminate manufacture.

The surface pattern, as described above, may be applied to the encapsulant layer through common art processes. For example, the extruded encapsulant layer may be passed over a specially prepared surface of a die roll positioned in close proximity to the exit of the die which imparts the desired surface characteristics to one side of the molten polymer. Thus, when the surface of such roll has minute peaks and valleys, the encapsulant layer formed of polymer cast thereon will have a rough surface on the side which contacts the roll which generally conforms respectively to the valleys and peaks of the roll surface. Such die rolls are disclosed in, for example, U.S. Pat. No. 4,035,549. As is known, this rough surface is only temporary and particularly functions to facilitate de-airing during laminating after which it is melted smooth from the elevated temperature and pressure associated with autoclaving and other lamination processes.

I.IV. Solar Cells:

Solar cells are commonly available on an ever increasing variety as the technology evolves and is optimized. Within the present invention, a solar cell is meant to include any article which can convert light into electrical energy. Typical art examples of the various forms of solar cells include, for example, single crystal silicon solar cells, polycrystal silicon solar cells, microcrystal silicon solar cells, amorphous silicon based solar cells, copper indium selenide solar cells, compound semiconductor solar cells, dye sensitized solar cells, and the like. The most common types of solar cells include multi-crystalline solar cells, thin film solar cells, compound semiconductor solar cells and amorphous silicon solar cells due to relatively low cost manufacturing ease for large scale solar cells.

Thin film solar cells are typically produced by depositing several thin film layers onto a substrate, such as glass or a flexible film, with the layers being patterned so as to form a plurality of individual cells which are electrically interconnected to produce a suitable voltage output. Depending on the sequence in which the multi-layer deposition is carried out, the substrate may serve as the rear surface or as a front window for the solar cell module. By way of example, thin film solar cells are disclosed in U.S. Pat. Nos. 5,512,107; 5,948,176; 5,994,163; 6,040,521; 6,137,048; and 6,258,620. Examples of thin film solar cell modules are those that comprise cadmium telluride or CIGS, (Cu(In—Ga)(SeS)2), thin film cells.

I.V. Incident Layers, Back-Sheet Layers, and Other Layers:

The solar cell module of the present invention may further comprise one or more sheet layers or film layers to serve as the incident layer, the back-sheet layer, and other additional layers.

The sheet layers, such as incident and back-sheet layers, used herein may be glass or plastic sheets, such as, polycarbonate, acrylics, polyacrylate, cyclic polyolefins, such as ethylene norbornene polymers, metallocene-catalyzed polystyrene, polyamides, polyesters, fluoropolymers and the like and combinations thereof, or metal sheets, such as aluminum, steel, galvanized steel, and ceramic plates. Glass may serve as the incident layer of the solar cell laminate and the supportive back-sheet of the solar cell module may be derived from glass, rigid plastic sheets or metal sheets.

The term “glass” is meant to include not only window glass, plate glass, silicate glass, sheet glass, low iron glass, tempered glass, tempered CeO-free glass, and float glass, but also includes colored glass, specialty glass which includes ingredients to control, for example, solar heating, coated glass with, for example, sputtered metals, such as silver or indium tin oxide, for solar control purposes, E-glass, Toroglass, Solex® glass (a product of Solutia) and the like. Such specialty glasses are disclosed in, for example, U.S. Pat. Nos. 4,615,989; 5,173,212; 5,264,286; 6,150,028; 6,340,646; 6,461,736; and 6,468,934. The type of glass to be selected for a particular laminate depends on the intended use.

The film layers, such as incident, back-sheet, and other layers, used herein may be metal, such as aluminum foil, or polymeric. Preferable polymeric film materials include poly(ethylene terephthalate), polycarbonate, polypropylene, polyethylene, polypropylene, cyclic polyloefins, norbornene polymers, polystyrene, syndiotactic polystyrene, styrene-acrylate copolymers, acrylonitrile-styrene copolymers, poly(ethylene naphthalate), polyethersulfone, polysulfone, nylons, poly(urethanes), acrylics, cellulose acetates, cellulose triacetates, cellophane, vinyl chloride polymers, polyvinylidene chloride, vinylidene chloride copolymers, fluoropolymers, polyvinyl fluoride, polyvinylidene fluoride, polytetrafluoroethylene, ethylene-tetrafluoroethylene copolymers and the like. Most preferably, the polymeric film is bi-axially oriented poly(ethylene terephthalate) (PET) film, aluminum foil, or a fluoropolymer film, such as Tedlar® or Tefzel® films, which are commercial products of the E. I. du Pont de Nemours and Company. The polymeric film used herein may also be a multi-layer laminate material, such as a fluoropolymer/polyester/fluoropolymer (e.g., Tedlar®/Polyester/Tedlar®) laminate material or a fluoropolymer/polyester/EVA laminate material.

The thickness of the polymeric film is not critical and may be varied depending on the particular application. Generally, the thickness of the polymeric film will range from about 0.1 to about 10 mils (about 0.003 to about 0.26 mm). The polymeric film thickness may be preferably within the range of about 1 mil (0.025 mm) to about 4 mils (0.1 mm).

The polymeric film is preferably sufficiently stress-relieved and shrink-stable under the coating and lamination processes. Preferably, the polymeric film is heat stabilized to provide low shrinkage characteristics when subjected to elevated temperatures (i.e. less than 2% shrinkage in both directions after 30 min at 150°).

The films used herein may serve as an incident layer (such as the fluoropolymer or poly(ethylene terephthalate) film) or a back-sheet (such as the fluoropolymer, aluminum foil, or poly(ethylene terephthalate) film). In addition, the films may be coated and included as dielectric layers or barrier layers, such as oxygen or moisture barrier layers. For example, the metal oxide coatings, such as those disclosed within U.S. Pat. Nos. 6,521,825; and 6,818,819 and European Patent No. EP 1 182 710, may function as oxygen and moisture barriers.

If desired, a layer of non-woven glass fiber (scrim) may be included in the present solar cell laminate 20 to facilitate de-airing during the lamination process or to serve as reinforcement for the encapsulant layer(s). The use of such scrim layers within solar cell laminates is disclosed within, for example, U.S. Pat. Nos. 5,583,057; 6,075,202; 6,204,443; 6,320,115; 6,323,416; and European Patent No. 0 769 818.

I.VI. Adhesives and Primers:

When even greater adhesion is desired, one or both surfaces of the solar cell laminate layers, such as the encapsulant layer(s), the incident layer, the back-sheet, and/or the solar cell layer may be treated to enhance the adhesion to other laminate layers. This treatment may take any form known within the art, including adhesives, primers, such as silanes, flame treatments, such as disclosed within U.S. Pat. Nos. 2,632,921; 2,648,097; 2,683,894; and 2,704,382, plasma treatments, such as disclosed within U.S. Pat. No. 4,732,814, electron beam treatments, oxidation treatments, corona discharge treatments, chemical treatments, chromic acid treatments, hot air treatments, ozone treatments, ultraviolet light treatments, sand blast treatments, solvent treatments, and the like and combinations thereof. For example, a thin layer of carbon may be deposited on one or both surfaces of the polymeric film through vacuum sputtering as disclosed in U.S. Pat. No. 4,865,711. Or, as disclosed in U.S. Pat. No. 5,415,942, a hydroxy-acrylic hydrosol primer coating that may serve as an adhesion-promoting primer for poly(ethylene terephthalate) films.

In a particular embodiment, the adhesive layer may take the form of a coating. The thickness of the adhesive/primer coating may be less than 1 mil, or preferably, less than 0.5 mil, or more preferably, less than 0.1 mil. The adhesive may be any adhesive or primer known within the art. Specific examples of adhesives and primers which may be useful in the present invention include, but are not limited to, gamma-chloropropylmethoxysilane, vinyltrichlorosilane, vinyltriethoxysilane, vinyltris(beta-methoxyethoxy)silane, gamma-methacryloxypropyltrimethoxysilane, beta-(3,4-epoxycyclohexyl)ethyltrimethoxysilane, gammaglycidoxypropyltrimethoxysilane, vinyl-triacetoxysilane, gamma-mercaptopropyltrimethoxysilane, gamma-aminopropyltriethoxysilane, N-beta-(aminoethyl)-gamma-aminopropyl-trimethoxysilane, glue, gelatine, caesin, starch, cellulose esters, aliphatic polyesters, poly(alkanoates), aliphatic-aromatic polyesters, sulfonated aliphatic-aromatic polyesters, polyamide esters, rosin/polycaprolactone triblock copolymers, rosin/poly(ethylene adipate) triblock copolymers, rosin/poly(ethylene succinate) triblock copolymers, poly(vinyl acetates), poly(ethylene-co-vinyl acetate), poly(ethylene-co-ethyl acrylate), poly(ethylene-co-methyl acrylate), poly(ethylene-co-propylene), poly(ethylene-co-1-butene), poly(ethylene-co-1-pentene), poly(styrene), acrylics, polyurethanes, sulfonated polyester urethane dispersions, nonsulfonated urethane dispersions, urethane-styrene polymer dispersions, non-ionic polyester urethane dispersions, acrylic dispersions, silanated anionic acrylate-styrene polymer dispersions, anionic acrylate-styrene dispersions, anionic acrylate-styrene-acrylonitrile dispersions, acrylate-acrylonitrile dispersions, vinyl chloride-ethylene emulsions, vinylpyrrolidone/styrene copolymer emulsions, carboxylated and noncarboxylated vinyl acetate ethylene dispersions, vinyl acetate homopolymer dispersions, polyvinyl chloride emulsions, polyvinylidene fluoride dispersions, ethylene acrylic acid dispersions, polyamide dispersions, anionic carboxylated or noncarboxylated acrylonitrile-butadiene-styrene emulsions and acrylonitrile emulsions, resin dispersions derived from styrene, resin dispersions derived from aliphatic and/or aromatic hydrocarbons, styrene-maleic anhydrides, and the like and mixtures thereof.

In another particular embodiment, the adhesive or primer is a silane that incorporates an amine function. Specific examples of such materials include, but are not limited to, gamma-aminopropyltriethoxysilane, N-beta-(aminoethyl)-gamma-aminopropyl-trimethoxysilane, and the like and mixtures thereof. Commercial examples of such materials include, for example A-1100® silane, (from the Silquest Company, formerly from the Union Carbide Company, believed to be gamma-aminopropyltrimethoxysilane) and Z6020® silane, (from the Dow Corning Corp.).

The adhesives may be applied through melt processes or through solution, emulsion, dispersion, and the like, coating processes. One of ordinary skill in the art will be able to identify appropriate process parameters based on the composition and process used for the coating formation. The above process conditions and parameters for making coatings by any method in the art are easily determined by a skilled artisan for any given composition and desired application. For example, the adhesive or primer composition can be cast, sprayed, air knifed, brushed, rolled, poured or printed or the like onto the surface. Generally the adhesive or primer is diluted into a liquid medium prior to application to provide uniform coverage over the surface. The liquid media may function as a solvent for the adhesive or primer to form solutions or may function as a non-solvent for the adhesive or primer to form dispersions or emulsions. Adhesive coatings may also be applied by spraying the molten, atomized adhesive or primer composition onto the surface. Such processes are disclosed within the art for wax coatings in, for example, U.S. Pat. Nos. 5,078,313; 5,281,446; and 5,456,754.

I.VII. Solar Cell Laminate Constructions:

Notably, specific solar cell laminate constructions (top (light incident) side to back side) include, but are not limited to, glass/the polymeric sheet disclosed herein/solar cell/the polymeric sheet disclosed herein/glass; glass/the polymeric sheet disclosed herein/solar cell/the polymeric sheet disclosed herein/Tedlar® film; Tedlar® film/the polymeric sheet disclosed herein/solar cell/the polymeric sheet disclosed herein/glass; Tedlar® film/the polymeric sheet disclosed herein/solar cell/the polymeric sheet disclosed herein/Tedlar® film; glass/the polymeric sheet disclosed herein/solar cell/the polymeric sheet disclosed herein/PET film; Tedlar® film/the polymeric sheet disclosed herein/solar cell/the polymeric sheet disclosed herein/PET film; glass/the polymeric sheet disclosed herein/solar cell/the polymeric sheet disclosed herein/barrier coated film/the polymeric sheet disclosed herein/glass; glass/the polymeric sheet disclosed herein/solar cell/the polymeric sheet disclosed herein/barrier coated film/the polymeric sheet disclosed herein/Tedlar® film; Tedlar® film/the polymeric sheet disclosed herein/barrier coated film/the polymeric sheet disclosed herein/solar cell/the polymeric sheet disclosed herein/barrier coated film/the polymeric sheet disclosed herein/Tedlar®) film; and the like. Preferably, the solar cell module of the present invention, has both the incident layer and the back-sheet formed of glass.

### Manufacture of Solar Cell Module or Laminate

In a further embodiment, the present invention is a process of manufacturing the solar cell module or laminate described above.

The solar cell laminates of the present invention may be produced through autoclave and non-autoclave processes, as described below. For example, the solar cell constructs described above may be laid up in a vacuum lamination press and laminated together under vacuum with heat and standard atmospheric or elevated pressure

In an exemplary process, a glass sheet, a front-sheet encapsulant layer, a solar cell, a back-sheet encapsulant layer and Tedlar® film, and a cover glass sheet are laminated together under heat and pressure and a vacuum (for example, in the range of about 27-28 inches (689-711 mm) Hg) to remove air. Preferably, the glass sheet has been washed and dried. A typical glass type is 90 mil thick annealed low iron glass. In an exemplary procedure, the laminate assembly of the present invention is placed into a bag capable of sustaining a vacuum (“a vacuum bag”), drawing the air out of the bag using a vacuum line or other means of pulling a vacuum on the bag, sealing the bag while maintaining the vacuum, placing the sealed bag in an autoclave at a temperature of about 120° C. to about 180° C., at a pressure of about 200 psi (about 15 bars), for from about 10 to about 50 minutes. Preferably the bag is autoclaved at a temperature of from about 120° C. to about 160° C. for 20 minutes to about 45 minutes. More preferably the bag is autoclaved at a temperature of from about 135° C. to about 160° C. for about 20 minutes to about 40 minutes. A vacuum ring may be substituted for the vacuum bag. One type of vacuum bags is disclosed within U.S. Pat. No. 3,311,517.

Any air trapped within the laminate assembly may be removed through a nip roll process. For example, the laminate assembly may be heated in an oven at a temperature of about 80° C. to about 120° C., or preferably, at a temperature of between about 90° C. and about 100° C., for about 30 minutes. Thereafter, the heated laminate assembly is passed through a set of nip rolls so that the air in the void spaces between the solar cell outside layers, the solar cell and the encapsulant layers may be squeezed out, and the edge of the assembly sealed. This process may provide the final solar cell laminate or may provide what is referred to as a pre-press assembly, depending on the materials of construction and the exact conditions utilized.

The pre-press assembly may then be placed in an air autoclave where the temperature is raised to about 120° C. to about 160° C., or preferably, between about 135° C. and about 160° C., and pressure to between about 100 psig and about 300 psig, or preferably, about 200 psig (14.3 bar). These conditions are maintained for about 15 minutes to about 1 hour, or preferably, about 20 to about 50 minutes, after which, the air is cooled while no more air is added to the autoclave. After about 20 minutes of cooling, the excess air pressure is vented and the solar cell laminates are removed from the autoclave. This should not be considered limiting. Essentially any lamination process known within the art may be used with the encapsulants of the present invention.

The laminates of the present invention may also be produced through non-autoclave processes. Such non-autoclave processes are disclosed, for example, within U.S. Pat. Nos. 3,234,062; 3,852,136; 4,341,576; 4,385,951; 4,398,979; 5,536,347; 5,853,516; 6,342,116; and 5,415,909, US Patent Application No. 2004/0182493, European Patent No. EP 1 235 683 B1, and PCT Patent Application Nos. WO 91/01880 and WO 03/057478 A1. Generally, the non-autoclave processes include heating the laminate assembly or the pre-press assembly and the application of vacuum, pressure or both. For example, the pre-press may be successively passed through heating ovens and nip rolls.

If desired, the edges of the solar cell laminate may be sealed to reduce moisture and air intrusion and their potentially degradation effect on the efficiency and lifetime of the solar cell by any means disclosed within the art. General art edge seal materials include, but are not limited to, butyl rubber, polysulfide, silicone, polyurethane, polypropylene elastomers, polystyrene elastomers, block elastomers, styrene-ethylene-butylene-styrene (SEBS), and the like.

### EXAMPLES

The following Examples are intended to be illustrative of the present invention, and are not intended in any way to limit the scope of the present invention. The solar cell interconnections are omitted from the examples below to clarify the structures, but any common art solar cell interconnections may be utilized within the present invention.

### Methods

The following methods are used in the Examples presented hereafter.

### I. Lamination Process 1:

The laminate layers described below are stacked (laid up) to form the pre-laminate structures described within the examples. For the laminate containing a film layer as the incident or back-sheet layer, a cover glass sheet is placed over the film layer. The pre-laminate structure is then placed within a vacuum bag, the vacuum bag is sealed and a vacuum is applied to remove the air from the vacuum bag. The bag is placed into an oven and while maintaining the application of the vacuum to the vacuum bag, the vacuum bag is heated at 135° C. for 30 minutes. The vacuum bag is then removed from the oven and allowed to cool to room temperature (25±5° C.). The laminate is then removed from the vacuum bag after the vacuum is discontinued.

### II. Lamination Process 2:

The laminate layers described below are stacked (laid up) to form the pre-laminate structures described within the examples. For the laminate containing a film layer as the incident or back-sheet layer, a cover glass sheet is placed over the film layer. The pre-laminate structure is then placed within a vacuum bag, the vacuum bag is sealed and a vacuum is applied to remove the air from the vacuum bag. The bag is placed into an oven and heated to 90-100° C. for 30 minutes to remove any air contained between the assembly. The pre-press assembly is then subjected to autoclaving at 135° C. for 30 minutes in an air autoclave to a pressure of 200 psig (14.3 bar), as described above. The air is then cooled while no more air is added to the autoclave. After 20 minutes of cooling when the air temperature reaches less than about 50° C., the excess pressure is vented, and the laminate is removed from the autoclave.

### Examples 1-10

12-inch by 12-inch solar cell laminate structures described below in Table 1 are assembled and laminated by Lamination Process 1. Layers 1 and 2 constitute the incident layer and the front-sheet encapsulant layer, respectively, and Layers 4 and 5 constitute the back-sheet encapsulant layer and the back-sheet, respectively.

TABLE 1
Solar Cell Laminate Structures

| Example | Layer 1 | Layer 2 | Layer 3 | Layer 4 | Layer 5 |
|---|---|---|---|---|---|
| 1, 11 | Glass 1 | Ionomer 1 | Solar Cell 1 | Ionomer 2 | Glass 1 |
| 2, 12 | Glass 2 | Ionomer 1 | Solar Cell 2 | Ionomer 1 | Glass 2 |
| 3, 13 | Glass 1 | Ionomer 3 | Solar Cell 3 | Ionomer 4 | Glass 2 |
| 4, 14 | Glass 1 | Ionomer 5 | Solar Cell 4 | Ionomer 6 | Glass 2 |
| 5, 15 | Glass 1 | Ionomer 7 | Solar Cell 1 | Ionomer 8 | Glass 3 |
| 6, 16 | Glass 1 | ACR 1 | Solar Cell 4 | ACR 3 | Glass 2 |
| 7, 17 | Glass 1 | ACR 2 | Solar Cell 1 | ACR 3 | Glass 2 |
| 8, 18 | Glass 2 | Ionomer 5 | Solar Cell 4 | ACR 3 | Glass 2 |
| 9, 19 | FPF | Ionomer 2 | Solar Cell 1 | Ionomer 1 | Glass 2 |
| 10, 20 | Glass 1 | Ionomer 3 | Solar Cell 4 | Ionomer 4 | FPF |

ACR 1 is a 10 mil (0.25 mm) thick embossed sheet derived from poly(ethylene-co-methacrylic acid) containing 15 wt % of polymerized residues of methacrylic acid and having a MI of 5.0 g/10 minutes (190° C., ISO 1133, ASTM D1238).
ACR 2 is a 20 mil (0.51 mm) thick embossed sheet derived from poly(ethylene-co-methacrylic acid) containing 18 wt % of polymerized residues of methacrylic acid and having a MI of 2.5 g/10 minutes (190° C., ISO 1133, ASTM D1238).
ACR 3 is a 60 mil (1.50 mm) thick embossed sheet derived from poly(ethylene-co-methacrylic acid) and having 21 wt % of polymerized residues of methacrylic acid and having a MI of 5.0 g/10 minutes (190° C., ISO 1133, ASTM D1238).
FPF is a corona surface treated Tedlar ® film (1.5 mil (0.038 mm) thick), a product of the DuPont Corporation.
Glass 1 is Starphire ® glass from the PPG Corporation.
Glass 2 is a clear annealed float glass plate layer (2.5 mm thick).
Glass 3 in a Solex ® solar control glass (3.0 mm thick).
Ionomer 1 is a 60 mil (1.50 mm) thick embossed sheet derived from poly(ethylene-co-methacrylic acid) containing 18 wt % of polymerized residues of methacrylic acid that is 35% neutralized with sodium ion and having a MI of 2.5 g/10 minutes (190° C., ISO 1133, ASTM D1238). Ionomer 1 is prepared from a poly(ethylene-co-methacrylic acid) having a MI of 60 g/10 minutes.
Ionomer 2 is a 20 mil (0.51 mm) thick embossed sheet derived from the same copolymer of Ionomer 1.
Ionomer 3 is a 90 mil (2.25 mm) thick embossed sheet derived from poly(ethylene-co-methacrylic acid) containing 18 wt % of polymerized residues of methacrylic acid that is 30% neutralized with zinc ion and having a MI of 1 g/10 minutes (190° C., ISO 1133, ASTM D1238). Ionomer 3 is prepared from poly(ethylene-co-methacrylic acid) having a MI of 60 g/10 minutes.
Ionomer 4 is a 20 mil (0.51 mm) thick embossed sheet derived from the same copolymer of Ionomer 3.
Ionomer 5 is a 20 mil (0.51 mm) thick embossed sheet derived from poly(ethylene-co-methacrylic acid) containing 20 wt % of polymerized residues of methacrylic acid that is 28% neutralized with zinc ion and having a MI of 1.5 g/10 minutes (190° C., ISO 1133, ASTM D1238). Ionomer 5 is prepared from poly(ethylene-co-methacrylic acid) having a MI of 25 g/10 minutes.
Ionomer 6 is a 60 mil (1.50 mm) thick embossed sheet derived from the same copolymer of Ionomer 5.
Ionomer 7 is a 20 mil (0.51 mm) thick embossed sheet derived from poly(ethylene-co-methacrylic acid) containing 22 wt % of polymerized residues of methacrylic acid that is 26% neutralized with zinc ion and having a MI of 0.75 g/10 minutes (190° C., ISO 1133, ASTM D1238). Ionomer 5 is prepared from poly(ethylene-co-methacrylic acid) having a MI of 60 g/10 minutes.
Ionomer 8 is a 90 mil (2.25 mm) thick embossed sheet derived from the same copolymer of Ionomer 7.
Solar Cell 1 is a 10-inch by 10-inch amorphous silicon photovoltaic device comprising a stainless steel substrate (125 micrometers thick) with an amorphous silicon semiconductor layer (U.S. Pat. No. 6,093,581, Example 1).
Solar Cell 2 is a 10-inch by 10-inch copper indium diselenide (CIS) photovoltaic device (U.S. Pat. No. 6,353,042, column 6, line 19).
Solar Cell 3 is a 10-inch by 10-inch cadmium telluride (CdTe) photovoltaic device (U.S. Pat. No. 6,353,042, column 6, line 49).
Solar Cell 4 is a silicon solar cell made from a 10-inch by 10-inch polycrystalline EFG-grown wafer (U.S. Pat. No. 6,660,930, column 7, line 61).

### Example 11-20

12-inch by 12-inch solar cell laminate structures described above in Table 1 are assembled and laminated by Lamination Process 2. Layers 1 and 2 constitute the incident layer and the front-sheet encapsulant layer, respectively, and Layers 4 and 5 constitute the back-sheet encapsulant layer and the back-sheet, respectively.

What is claimed is:

1. A solar cell module comprising at least one encapsulant layer and a solar cell layer comprising one or a plurality of electronically interconnected solar cells and having a light-receiving surface and a rear surface, wherein said at least one encapsulant layer is laminated to one surface of said solar cell layer and formed of a first polymeric sheet comprising a first polymeric composition selected from the group consisting of acid copolymers, ionomers derived therefrom, and combinations thereof and having a thickness greater than or equal to 50 mils (1.25 mm).

2. The solar cell module of claim 1, wherein said at least one encapsulant layer is a back-sheet encapsulant layer that is laminated to the rear surface of said solar cell layer.

3. The solar cell module of claim 2, wherein said first polymeric sheet has a thickness greater than or equal to 60 mils (1.50 mm).

4. The solar cell module of claim 1, wherein said acid copolymer comprises polymerized residues of an α-olefin having 2 to 10 carbon atoms and greater than or equal to 1 wt % of polymerized residues of an α,β-ethylenically unsaturated carboxylic acid based on the total weight of the copolymer and has a melting index (MI) less than 60 g/10 min at 190° C.

5. The solar cell module of claim 4, wherein said acid copolymer comprises about 15 to about 25 wt % of polymerized residues of said α,β-ethylenically unsaturated carboxylic acid based on the total weight of the copolymer.

6. The solar cell module of claim 5, wherein said acid copolymer comprises about 18 to about 23 wt % of polymerized residues of said α,β-ethylenically unsaturated carboxylic acid based on the total weight of the copolymer.

7. The solar cell module of claim 4, wherein said α-olefin is selected from the group consisting of ethylenes, propylenes, 1-butenes, 1-pentenes, 1-hexenes, 1-heptenes, 3-methyl-1-butenes, 4-methyl-1-pentenes, and mixtures thereof.

8. The solar cell module of claim 4, wherein said α,β-ethylenically unsaturated carboxylic acid is selected from the group consisting of acrylic acids, methacrylic acids, itaconic acids, maleic acids, maleic anhydrides, fumaric acids, monomethyl maleic acids, and mixtures thereof.

9. The solar cell module of claim 1, wherein said ionomer is derived from said acid copolymer which has been neutralized from about 10% to about 100% with metallic ions based on a total carboxylic acid content.

10. The solar cell module of claim 2, further comprising a front-sheet encapsulant layer that is formed of a second polymeric sheet comprising a second polymeric composition selected from the group consisting of poly(vinyl butyral), ionomers, ethylene vinyl acetate (EVA), acoustic poly(vinyl acetal), acoustic poly(vinyl butyral), polyvinylbutyral (PVB), thermoplastic polyurethane (TPU), polyvinylchloride (PVC), metallocene-catalyzed linear low density polyethylenes, polyolefin block elastomers, ethylene acrylate ester copolymers, acid copolymers, silicone elastomers and epoxy resins.

11. The solar cell module of claim 10, wherein said second polymeric composition is selected from the group consisting of said acid copolymer, said ionomer derived therefrom, and said combination thereof, and said first and second polymeric sheets have a total thickness greater than or equal to 70 mils (1.78 mm).

12. The solar cell module of claim 11, wherein said first and second polymeric compositions are chemically distinct.

13. The solar cell module of claim 10, further comprising an incident layer laminated to said front-sheet encapsulant layer and away from said solar cell layer, and a back-sheet laminated to said back-sheet encapsulant layer and away from said solar cell layer.

14. The solar cell module of claim 13, wherein said incident layer is formed of transparent material selected from the group consisting of glass and fluoropolymers.

15. The solar cell module of claim 13, wherein said back-sheet is formed of a sheet or film selected from the group consisting of glass, plastic sheets or films, and metal sheets or films.

16. The solar cell module of claim 1, wherein said one or a plurality of solar cells are selected from the group consisting of multi-crystalline solar cells, thin film solar cells, compound semiconductor solar cells, and amorphous silicon solar cells.

17. A solar cell module consisting essentially of, from top to bottom, (i) an incident layer that is laminated to, (ii) a front-sheet encapsulant layer that is laminated to, (iii) a solar cell layer comprising one or a plurality of electronically interconnected solar cells, which is laminated to, (iv) a back-sheet encapsulant layer that is laminated to, (v) a back-sheet, wherein said back-sheet encapsulant layer is formed of a first polymeric sheet comprising a first polymeric composition selected from the group consisting of acid copolymers, ionomers derived therefrom, and combinations thereof and having a thickness greater than or equal to 50 mils (1.25 mm).

18. The solar cell of claim 17, wherein said front-sheet encapsulant layer is formed of a second polymeric sheet comprising a second polymeric composition selected from the group consisting of said acid copolymers, said ionomers derived therefrom, and said combinations thereof and said first and second polymeric sheets have a total thickness greater than or equal to 70 mils (1.78 mm).

19. A process of manufacturing a solar cell module comprising: (i) providing an assembly comprising, from top to bottom, an incident layer, a front-sheet encapsulant layer, a solar cell layer comprising one or a plurality of electronically interconnected solar cells, a back-sheet encapsulant layer, and a back-sheet and (ii) laminating the assembly to form the solar cell module, wherein said back-sheet encapsulant layer is formed of a first polymeric sheet comprising a first polymeric composition selected from the group consisting of acid copolymers, ionomers derived therefrom, and combinations thereof and having a thickness greater than or equal to 50 mils (1.25 mm).

20. The process of claim 19, wherein said front-sheet encapsulant layer is formed of a second polymeric sheet comprising a second polymeric composition selected from the group consisting of said acid copolymers, said ionomers derived therefrom, and said combinations thereof and said first and second polymeric sheets have a combined thickness greater than or equal to 70 mils (1.78 mm).

21. The process of claim 19, wherein the step (ii) of lamination is conducted by subjecting the assembly to heat.

22. The process of claim 21, wherein the step (ii) of lamination further comprises subjecting the assembly to pressure.

23. The process of claim 21, wherein the step (ii) of lamination further comprises subjecting the assembly to vacuum.
